(19) United States
(12) Patent Application Publication
(10) Pub. No.: US 2005/0216679 A1
(43) Pub. Date: Sep. 29, 2005

(54) Hard disk automatic hardware-based scheduled archiving

(76) Inventor: Itzhak Levy, Hollywood, FL (US)

Correspondence Address: LERNER AND GREENBERG, PA, P O BOX 2480, HOLLYWOOD, FL, 33022-2480, US

(21) Appl. No.: 10/809,220

(22) Filed: Mar. 25, 2004

(51) Int. Cl. G06F 12/16

(52) U.S. Cl. 711/162; 711/114

(57) ABSTRACT

The present invention relates to an intermediate hard disk drive adapter for a computer system and, in particular, to an inexpensive high performance, high reliability intermediate hard disk drive adapter for a computer system that allows periodic multiple data archiving.

### BACKGROUND OF THE INVENTION

1. Field of the Invention

The invention lies in the computer storage technology field. More specifically, the invention relates to an intermediate hard disk drive adapter for a computer system.

The term “computer system” as used herein should be understood in a very wide sense of the term. While the most common use of the invention will likely be with desktop computers or servers, the device according to the invention works with a multitude of other specialized devices such as point-of-sale terminals, telephony, computer numerical controllers, medical testing and monitoring equipment, and many other similar systems and devices. The invention should be understood to broadly apply to all such systems and devices.

2. Description of the Related Art

As the use of computers has greatly increased and the amount and complexity of software has grown, the amount of data storage required has increased enormously. Data stored on a computer is generally extremely valuable because it is the result of a great deal of time and effort. If such data is lost, much time and effort would need to be duplicated to reconstruct it. In some cases, reconstructing the data is not possible. For this reason, it is desirable to store data in more than one location. Additionally computer viruses or operator errors can corrupt data in a manner that might not be noticed for several days.

Data should be stored in multiple locations automatically to assure that data is backed up without relying on an operator who might intentionally or inadvertently fail to backup manually., as wel as the most often cause of data loss which is mechanical failure of the hard drive or a system component.

If data is lost, it is important that it be restored quickly to minimize the loss of time and money.

The most common method of long term storage of programs and data on present day computer systems is the hard disk drive. A hard disk drive is an electromechanical device consisting of one or more rotating platters or disks, a movable electromagnetic transducer, and electronics to convey the information between the central processor and the disks.

The hard disk drive, while designed to be very reliable, is prone to failure because of the high speed mechanical operations that it is required to perform. Since failure of the hard disk drive may destroy all the programs and data that it contains, recovery to normal operation is difficult or impossible if the programs and data cannot be restored from another source. For this reason, a number of different means to copy or “back up” hard disk programs and data have been developed.

Programs and data can be transferred (backed up) to another medium such as floppy disks, magnetic tape, CDROMS, or other high density removable disk media. These methods, however, are slow, require significant operator intervention, and require the dedication of the central processor for the duration of the transfer. Floppy disks contain a very small amount of data by today's standards. Any operation that involves transferring data to a number of storage devices is prone to error by the computer operator. Additionally the reliability of floppy disks and other removable media disks, magnetic tape, and CDROMS is low. Programs and data can be transferred over a computer network and stored on a second computer. This has several disadvantages, namely:
multiple computers are required, as well as a computer network to interconnect them;
significant resources are required from the central processor;
special software (programs) to accomplish the transfer;
significant time is required to restore the lost data; and
the computer cannot be immediately started (bootstrapped) without replacing the operating system.

Additionally, there are a number of different schemes to back up programs and data on multiple hard disk drives. This invention addresses one of these schemes.

### SUMMARY OF THE INVENTION

The present invention in its simplest form involves the use of an intermediate hard disk controller and the addition of one additional hard disk drive known as the “backup hard disk drive”. The unique feature of the present invention is that the backup hard disk drive is at least twice and typically 5 to 7 times the size of the hard disk drive normally used by the computer. It is divided into physical partitions that are each the size of the computer's normal hard disk drive. These partitions could represent the days of the week or any other desired interval. The intermediate hard disk controller changes access to the physical partition and backs up the normal hard disk drive of the computer, the schedule of backup times being selected by the user, on a regular or irregular basis as desired. The backup hard disk drive would have the number of physical partitions required for the desired backup scheme. As an example a typical backup of a hard disk drive would have 5 physical partitions for daily backup on business days, 7 physical partitions for daily backup of each day allowing complete data to be stored for a week. The actual number of partitions is only limited by the size of the hard disk drives involved, that number being selected by the user. This protects the user's data because there are archived versions of the data in the case that data on the computer's drive becomes corrupted by a computer virus or operator error or hard disk failure. If information is completely destroyed on the current hard disk, the computer can be restarted (bootstrapped) from any previous archived version on the backup hard disk drive, the desired version being selected by an electrical switching scheme. This can be done immediately with a very small loss of time and productivity. A number of backup copies of data are kept because often a computer virus or serious data corruption might not be noticed for several days. If it is necessary to restore the data from the backup hard disk drive, only data entered subsequent to the backup version would need to be manually restored.

The invention is a completely hardware implementation. Another unique feature of the invention is that it is inserted directly between the data connector from the computer and the data connectors on the hard disk drives. After a utility program is used to correctly initialize the hard disk drive, the computer and its operating system have no cognizance of the invention. Thus the invention is completely transparent to the type of computer or its operating system. The invention can be designed to communicate with both the computer and the hard disk drives using any commonly used or future hard disk drive communication scheme.

It is accordingly an object of the invention to provide a communications method which overcomes the above-mentioned disadvantages of the heretofore-known devices and methods of this general type and which provides for a system and hardware solution to the problem of data archiving while achieving higher performance, higher data availability, and lower cost.

With the foregoing and other objects in view there is provided, in accordance with the invention, a computer system, comprising a processor generating data output, a hard disk drive adapter designed to function as an intermediate adapter connected to receive the data output from the processor and configured to send the data output to one or more channels, and a plurality of data storage devices each connected to the intermediate adapter and each receiving the data output of a respective channel. Additionally the hard disk drive adapter allows data to be transferred from one hard disk drive channel to another and from any hard disk drive channel to the processor.

In accordance with another feature of the invention, the intermediate adapter is configured to implement substantially automatic hard disk drive data archiving.

In other words, the present invention is a dedicated electronic version of an archiving system. In its simplest form, it is configured to connect to one hard disk drive port from the central processor and to two hard disk drives, one of which is the computer's normal operating hard disk, and the other which is several times larger and divided into physical partitions, allowing for archived copies of the normal operating hard disk.

The invention has several advantages. By way of example, inter alia, the invention
enables the implementation of automatic archiving of hard disk drive data;
helps prevent the loss of all data and lost time when a hard disk drive failure occurs;
enables computer recovery in case of computer viruses or operator errors that destroy the current data on the hard disk drive;
provides for a hard disk drive adapter designed to function as an intermediate adapter, thereby eliminating the need to use other central processor resources such as expansion card slots, interrupts, input/output space, and address space;
provides an intermediate adapter designed to function without requiring device drivers or any support by the operating system itself; and
provides the ability to use removable hard disk drives that can be taken off-site or stored in a secure location.

Other features which are considered as characteristic for the invention are set forth in the appended claims.

Although the invention is illustrated and described herein as embodied in a hardware-based scheduled archiving process and system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWING

FIG. 1 is a block diagram of a system incorporating the interface according to the invention;

FIG. 2 is a table indicating the contents of a typical 40 GB hard disk drive;

FIG. 3 is cross-reference, in tabular form, containing the physical partitions and the logical partitions of a hard disk drive according to the invention;

FIG. 4 is a table with calculated block numbers using the data of FIG. 3; and

FIG. 5 is a block diagram of a system for calculating desired block numbers.

### DESCRIPTION OF THE PREFERRED EMBODIMENTS

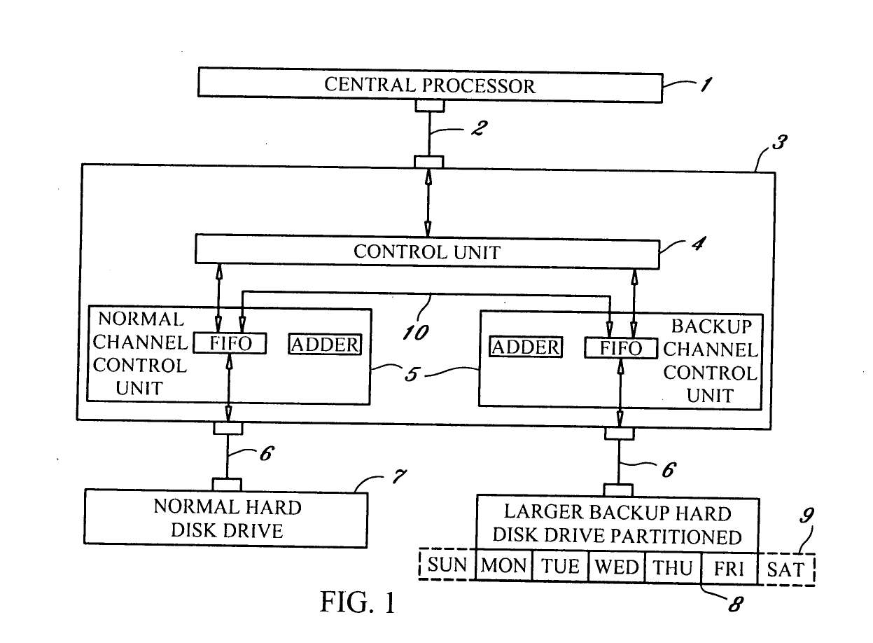

Referring now to the figures of the drawing in detail, and first, particularly, to FIG. 1, there is shown a block diagram illustrating, by way of example, a hard disk array system for a personal computer system or a small network server 1. A central processor communicates with an intermediate adapter 3.

The intermediate adapter 3 according to the invention has a control unit 4 which communicates with the central processor via a cable or connector 2. The control unit 4 accepts commands from the central processor 1 and generates several signals for division into a plurality of channel control units 5. In the case where data is requested from the hard disk drive, the control unit selects the appropriate hard disk drive and partition to be read. In the case where data needs to be backed up or restored, the control unit routes the data from one hard disk drive to another via internal bus 10 with no intervention from the central processor 1. The control unit also handles error reporting and recovery. Each channel control unit 5 contains a First-In-First-Out (FIFO) memory device for buffering the data, in both directions, between the central processor 1 and the hard disk drives or between the normal hard disk drive 7 and the backup hard disk drive (Two typical examples are given, a five day backup hard disk drive 8 and a seven day backup hard disk drive 9. Any other backup scheme may be used). Each channel communicates with a respective hard disk drive 7 and either 8 or 9, independently of each other or of the central processor, via a cable 6 or directly via a connector 6.

The following paragraphs describe the unique method by which the invention stores and retrieves information from different partitions of the backup hard disk drive.

Data is stored on hard disks in quantities of 512 bytes of information. These are known as “blocks”. Each block is located by a unique number, or address. This address is known as its “Logical Block Address” or “LBA” for short. For example a 40 Gigabyte (GB) hard drive would have 83,886,080 blocks, with addresses numbered from 0 to 83,886,079. In most computers, the software operating system stores information in specific blocks to allow the computer to power up (bootstrap) properly and to be able to efficiently find where various programs and data are stored on the hard disk.

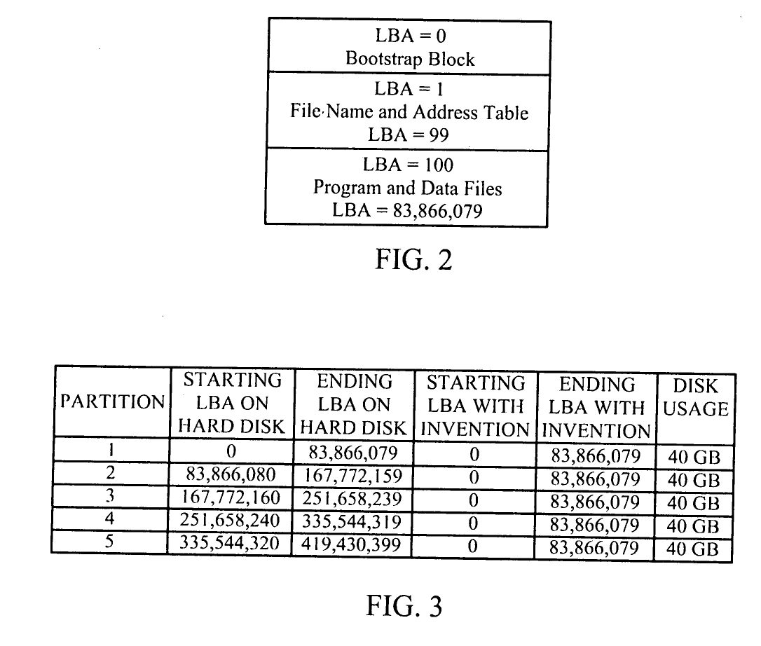

A typical operating system might consist of a bootstrap block at the first block, then a table of program and data files on the hard disk and where they are located. This would be followed by the program and data files, themselves. FIG. 2 is an illustration of the typical structure of a 40 GB hard disk.

This invention is unique in that it uses a hard disk (the backup disk) that is several times larger than the hard disk normally used by the computer (the system disk). For example, if the system disk size is 40 GB, the backup disk might contain 200 GB to be divided into five 40 GB partitions. Also the use of an a disk controller creates a full image to each partition, thus creating multiple bootable partition Referring to FIG. 3, this invention modifies the logical block addresses of the backup disk so that the computer at any one time sees one of five 40 GB drives. Each drive, as seen by the computer, appears to have exactly the same block addresses as the system disk. Thus the computer can power up from the selected partition and access all program and data files as if it were the system disk of the computer. To the system, any one of the partitions looks and behaves exactly like a physical hard disk drive.

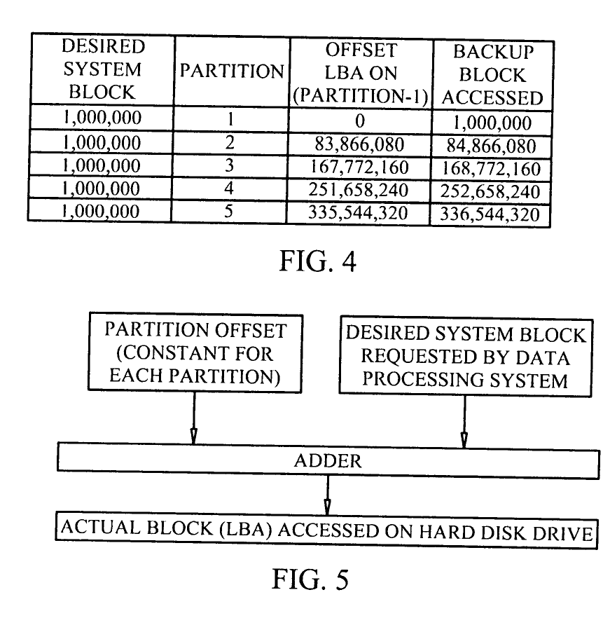

The address of the desired block to be accessed on the backup hard disk is calculated by adding an offset to the address of the block desired by the computer on the system disk. This offset is calculated by multiplying the total number of logical blocks on the system disk of the computer by one less than the desired partition on the backup disk. An example showing a backup disk with a size of 200 GB divided into five 40 GB partitions is shown in FIG. 4. The method of calculating desired block numbers is illustrated in FIG. 5.

1. A computer system, comprising:
a processor generating data output;
a hard disk drive adapter forming an intermediate adapter connected to receive the data output from said processor and configured to write the data output to a plurality of channels;
a plurality of data storage devices each connected to a respective channel of said hard disk drive adapter and connected to receive and store the data output; and
wherein said intermediate adapter is configured to archive the data from one of said channels to another one of said channels defined as a backup channel, substantially without intervention and resource utilization of said processor.

2. The computer system according to claim 1, wherein said processor is a central processor with a hard disk drive connector communicating with said intermediate adapter.

3. The computer system according to claim 1, which comprises a plurality of interfaces each for communicating with a respective one of said storage devices, and means for archiving data from one of said storage devices to another one of said storage devices designated a backup storage device.

4. The computer system according to claim 3, wherein said backup storage device has a storage capacity several times larger than said source device.

5. The computer system according to claim 4, wherein said intermediate adapter is configured to effect automatic data backup to said backup storage device.

6. The computer system according to claim 3, wherein said backup storage device is a partitioned drive with a partition size substantially corresponding with a size of said one storage device, and said intermediate adapter is configured to alternatingly back up data from said one storage device to individual partitions of said backup storage device.

7. The computer system according to claim 3, wherein said backup storage device has a partition for each of a plurality of days of the week, and said intermediate adapter is configured to back up data on given days of the week to the respective said partition on said backup storage device.

8. In a computer system having a processor generating data output and at least one data storage device for receiving and storing the data output, the improvement which comprises:
a plurality of data storage devices including a main storage device and a backup storage device with a storage capacity two or more times larger thana storage capacity of said main storage device;
an intermediate adapter connected between the processor and said data storage devices for receiving the data output from the processor and for outputting the data to said data storage devices;
said intermediate adapter being configured for distributing the data output to a plurality of channels by calculating an actual storage location on said data storage device; and
a plurality of connections connecting each of the channels to a respective one of said data storage devices.

9. The computer system according to claim 8, wherein said connections are cables or connectors connecting said channels of said intermediate adapter to said data storage devices.

10. The computer system according to claim 8, wherein said intermediate adapter is entirely transparent to an operation of the computer system and said storage device.
